(19) United States
(12) Patent Application Publication
(10) Pub. No.: US 2014/0331094 A1
(43) Pub. Date: Nov. 6, 2014

(54) INFORMATION PROCESSING SYSTEM AND INFORMATION PROCESSING METHOD

(71) Applicant: FUJI XEROX CO., LTD., Tokyo (JP)

(72) Inventors: Hiroyuki ENOMOTO, Kanagawa (JP); Tetsuya KOBAYASHI, Kanagawa (JP); Teppei AOKI, Kanagawa (JP); Tadaaki SATO, Kanagawa (JP); Makoto SATO, Kanagawa (JP)

(73) Assignee: FUJI XEROX CO., LTD., Tokyo (JP)

(21) Appl. No.: 14/185,307

(22) Filed: Feb. 20, 2014

(30) Foreign Application Priority Data
May 2, 2013 (JP) 2013-096966

(51) Int. Cl. G06F 11/07

(52) U.S. Cl. CPC G06F 11/0784
USPC 714/49

(57) ABSTRACT

An information processing system includes a terminal apparatus an information processing apparatus. The terminal apparatus includes a first language information memory; a first display displaying a processing parameter option used in information processing in a first language; a first acceptance unit accepting a first instruction; a first generation unit generating first instruction data; an instruction data transmission unit; a notification data reception unit receiving notification data; and a first notification unit. The information processing apparatus includes a second language information memory; a second display displaying the processing parameter option in a second language; a second acceptance unit accepting a second instruction; a second generation unit generating second instruction data; an instruction data reception unit; an identification unit identifying the information processing; an execution unit executing the information processing; a notification data acquisition unit; a notification data transmission unit; and a second notification unit.

### CROSS-REFERENCE TO RELATED APPLICATIONS

This application is based on and claims priority under 35 USC 119 from Japanese Patent Application No. 2013-096966 filed May 2, 2013.

### BACKGROUND

1. Technical Field

The present invention relates to an information processing system and an information processing method.

2. Summary

According to an aspect of the invention, there is provided an information processing system includes a terminal apparatus and an information processing apparatus. The terminal apparatus includes a first language information memory that stores first language information representing a first language as language information indicating a display mode of a language in the terminal apparatus; a first display that displays a processing parameter option used in information processing in the first language based on the first language information; a first acceptance unit that accepts a first instruction instructing the information processing apparatus to execute the information processing with an operation to select the option while displaying the option in the first language with the first display; a first generation unit that generates first instruction data representing the first instruction; an instruction data transmission unit that transmits the first instruction data to the information processing apparatus; a notification data reception unit that receives notification data indicating the content of an error that has occurred in the information processing apparatus and an action to resolve the error from the information processing apparatus; and a first notification unit that notifies a user of the content of the error and the action in the first language based on the notification data received by the notification data reception unit. The information processing apparatus includes a second language information memory that stores second language information representing a second language different from the first language as language information indicating a display mode of a language in the information processing apparatus; a second display that displays the processing parameter option in the second language based on the second language information; a second acceptance unit that accepts a second instruction indicating the execution of the information processing with an operation to select the option while displaying the option in the second language with the second display; a second generation unit that generates second instruction data representing the second instruction; an instruction data reception unit that receives the first instruction data transmitted from the instruction data transmission unit; an identification unit that identifies the information processing the execution of which is indicated based on the first instruction data received by the instruction data reception unit or the second instruction data generated by the second generation unit; an execution unit that executes the information processing identified by the identification unit; a notification data acquisition unit that acquires the notification data indicating the content of the error and the action; a notification data transmission unit that transmits the notification data acquired by the notification data acquisition unit to the terminal apparatus identified by information indicating a transmission source included in the first instruction data; and a second notification unit that notifies a user of the content of the error and the action in the second language based on the acquired notification data.

### BRIEF DESCRIPTION OF THE DRAWINGS

Exemplary embodiments of the present invention will be described in detail based on the following figures, wherein:

FIG. 1 illustrates an example of the entire configuration of an information processing system according to an exemplary embodiment of the present invention;

FIG. 2 is a block diagram illustrating an exemplary hardware configuration of an image forming apparatus according to an exemplary embodiment of the present invention;

FIG. 3 is a block diagram illustrating an exemplary hardware configuration of a terminal apparatus according to an exemplary embodiment of the present invention;

FIG. 4 illustrates an exemplary operation screen displayed in the image forming apparatus according to the exemplary embodiment;

FIGS. 5A and 5B illustrate exemplary operation screens displayed in the terminal apparatus (English) according to the exemplary embodiment;

FIGS. 6A and 6B illustrate exemplary operation screens displayed in the terminal apparatus (Japanese) according to the exemplary embodiment;

FIGS. 7A and 7B illustrate exemplary operation screens displayed in the terminal apparatus (Vietnamese) according to the exemplary embodiment;

FIG. 8 is a block diagram illustrating an exemplary functional configuration of the terminal apparatus and the image forming apparatus according to the exemplary embodiments;

FIG. 9 is a flowchart illustrating an exemplary process in the image forming apparatus according to the exemplary embodiment;

FIG. 10 is a sequence chart illustrating an exemplary process in the information processing system according to the exemplary embodiment;

FIG. 11 is a sequence chart illustrating another exemplary process in the information processing system according to the exemplary embodiment;

FIG. 12 illustrates an error notification screen displayed in the image forming apparatus according to the exemplary embodiment; and

FIGS. 13A to 13C illustrate error notification screens displayed in the terminal apparatus according to the exemplary embodiment.

### DETAILED DESCRIPTION

Exemplary embodiments of the present invention will herein be described with reference to the attached drawings.

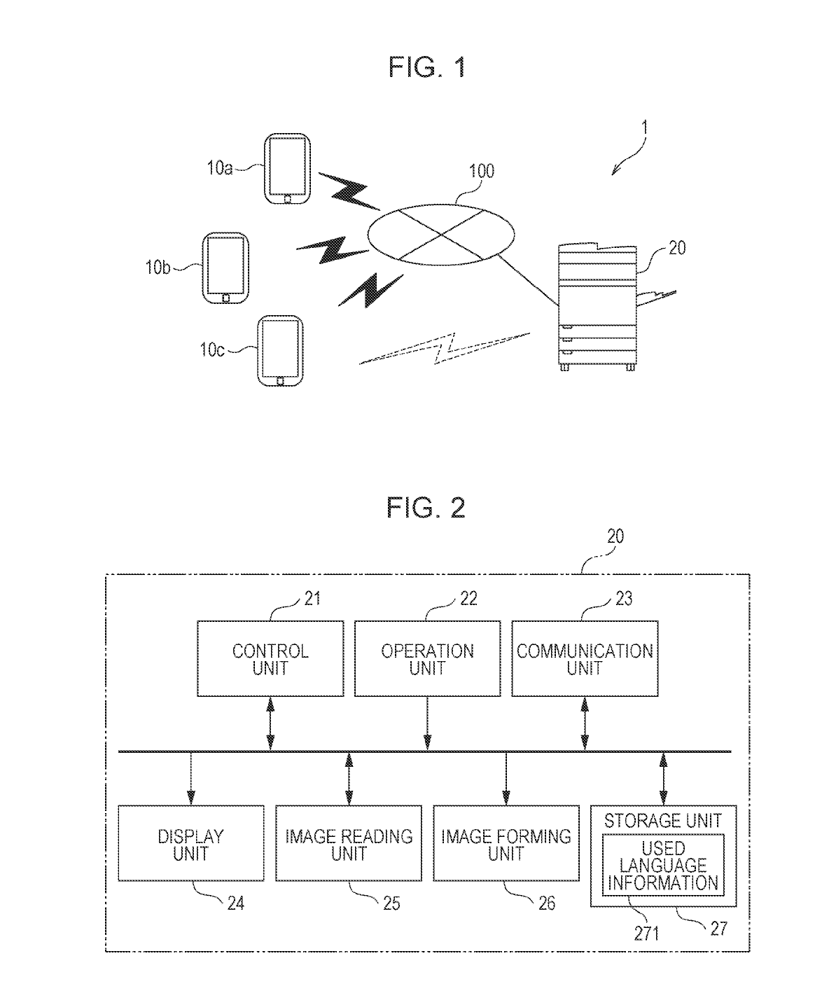

FIG. 1 illustrates an example of the entire configuration of an information processing system 1. Referring to FIG. 1, the information processing system 1 includes multiple terminal apparatuses 10 and an image forming apparatus 20. Three terminal apparatuses: a terminal apparatus 10a, a terminal apparatus 10b, and a terminal apparatus 10c, among the multiple terminal apparatuses 10, are illustrated in FIG. 1. Each of the multiple terminal apparatuses 10 and the image forming apparatus 20 is connected to a communication line 100. Although the communication line 100 is, for example, a Wireless Fidelity (Wi-Fi) (registered trademark) network, the kind of the communication line is not particularly specified.

The terminal apparatuses 10 each instruct the image forming apparatus 20 to execute information processing via the communication line 100. The terminal apparatus 10 indicates the execution of the information processing, such as a copy process, a scanning process, or a facsimile transmission process. The terminal apparatus 10 is, for example, a smartphone. In the present exemplary embodiment, the terminal apparatuses 10a, 10b, and 10c are operated (used) by different users. The image forming apparatus 20 is an example of an information processing apparatus according to an exemplary embodiment of the present invention and executes the information processing, such as the copy process, the scanning process, or the facsimile transmission process. The image forming apparatus 20 executes the information processing indicated by the user who operates the terminal apparatus 10 and executes the information processing directly indicated by the user who operates the image forming apparatus 20.

The terminal apparatus 10 may be another terminal apparatus, such as a mobile phone terminal, a tablet terminal, a laptop, a personal digital assistant (PDA), or a mobile game machine. As illustrated by broken lines in FIG. 1, the terminal apparatus 10 may directly communicate with the image forming apparatus 20 by using, for example, an ad hoc mode in a wireless local area network (LAN).

FIG. 2 is a block diagram illustrating an exemplary hardware configuration of the image forming apparatus 20. Referring to FIG. 2, the image forming apparatus 20 includes a controller 21, an operation unit 22, a communication unit 23, a display 24, an image reading unit 25, an image forming unit 26, and a memory 27.

The controller 21 is a controller that includes arithmetic devices including a central processing unit (CPU) and an application specific integrated circuit (ASIC) and memories. The controller 21 controls each component in the image forming apparatus 20. The operation unit 22 is an operation device that accepts an operation by the user and includes, for example, a touch screen and physical keys superposed on a display screen of the display 24. The communication unit 23 includes an interface to be connected to the communication line 100 or to be connected to a telephone line or the Internet, which are not illustrated, for communication. For example, the communication unit 23 transmits data to the terminal apparatus 10 through the communication line 100 or receives data from the terminal apparatus 10 through the communication line 100. The display 24 is, for example, a liquid crystal display and displays various images (screens) on the display screen on which images are to be displayed to notify the user of information. The image reading unit 25 is, for example, a scanner and reads out an image of a document to supply image data representing the image that is read out to the controller 21. The image forming unit 26 is, for example, a printer that forms an image on a sheet by an electrophotographic process. The memory 27 is, for example, a storage device including a hard disk device and stores a control program executed by the controller 21 and used language information 271.

The used language information 271 indicates the display mode of a language (more specifically, a natural language) in the image forming apparatus 20. In the image forming apparatus 20, the language used to display characters is determined from the used languages indicated by the used language information 271. When the image forming apparatus 20 supports multiple used languages, the memory 27 stores pieces of used language information 271 corresponding to the multiple used languages. In this case, the image forming apparatus 20 displays the characters in the language set by the user, among the multiple used languages. The image forming apparatus 20 typically displays the characters in a language commonly used by many users (for example, English when the image forming apparatus 20 is used in the United States).

In the present exemplary embodiment, the used language information 271 indicates that the used language includes only English. Accordingly, in the image forming apparatus 20, the characters are displayed in English. However, characters other than English characters, such as Japanese characters (for example, hiragana, katakana, and/or Kanji characters (Chinese characters)) and/or Arabic numerals, may also be displayed in the image forming apparatus 20.

When the copy process is executed in the image forming apparatus 20 having the above configuration, the controller 21 causes the image reading unit 25 to read out an image of a document. Then, the controller 21 causes the image forming unit 26 to form an image corresponding to image data generated by the image reading unit 25 on a sheet. When the scanning process is executed in the image forming apparatus 20, the controller 21 causes the image reading unit 25 to read out an image of a document. Then, the controller 21 causes the memory 27 to store image data generated by the image reading unit 25 or causes the communication unit 23 to transmit the data. When the facsimile transmission process is executed in the image forming apparatus 20, the controller 21 causes the image reading unit 25 to read out an image of a document. Then, the controller 21 causes the communication unit 23 to transmit image data generated by the image reading unit 25 by facsimile via a telephone line (not illustrated).

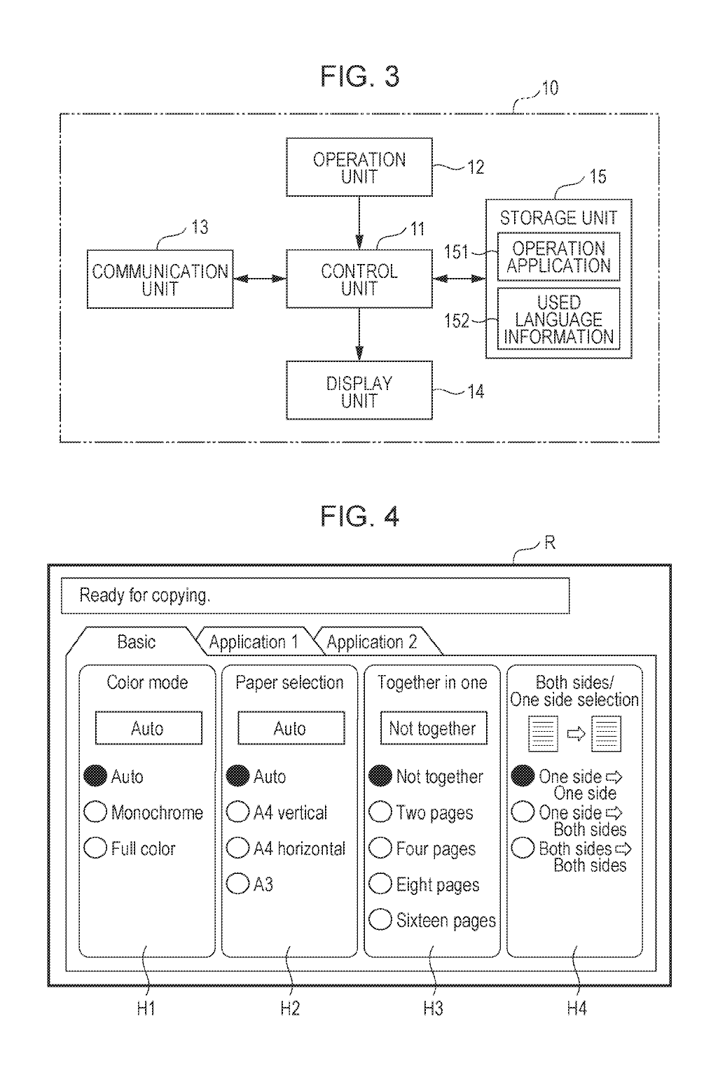

FIG. 3 is a block diagram illustrating an exemplary hardware configuration of the terminal apparatus 10. Referring to FIG. 3, the terminal apparatus 10 includes a controller 11, an operation unit 12, a communication unit 13, a display 14, and a memory 15.

The controller 11 includes a microcomputer including a CPU, a read only memory (ROM), and a random access memory (RAM). The CPU reads out a program stored in the ROM or the memory 15 into the RAM and executes the program that is read out to control each component in the terminal apparatus 10. The operation unit 12 is an operation device that accepts an operation by the user and includes, for example, a touch screen and physical keys superposed on a display screen of the display 14. The communication unit 13 includes an interface to be connected to the communication line 100 or to be connected to a communication network, such as a mobile communication network (not illustrated) for communication. For example, the communication unit 13 transmits data to the image forming apparatus 20 through the communication line 100 or receives data from the image forming apparatus 20 through the communication line 100. The display 14 is, for example, a liquid crystal display and displays various images (screens) on the display screen on which images are to be displayed to notify the user of information.

The memory 15 includes a storage device, such as an electrically erasable and programmable ROM (EEPROM) or a flash memory and stores, for example, an operation application 151 and used language information 152. The operation application 151 is, for example, an application program operating on an operating system (OS) of the terminal apparatus 10. The controller 11 executes the operation application 151 to realize a function to instruct the image forming apparatus 20 to execute the information processing.

The used language information 152 indicates the display mode of a language (a natural language) in the terminal apparatus 10. When a function to set the language used to display characters in the terminal apparatus 10 is installed in the OS used by the terminal apparatus 10, the used language information 152 may be stored in the memory 15 by the function of the OS. In the terminal apparatus 10, the language used to display the characters is determined from the used languages indicated by the used language information 152. The terminal apparatus 10 supports multiple used languages. In the present exemplary embodiment, the terminal apparatus 10 supports three languages: English, Japanese, and Vietnamese. The terminal apparatus 10a is set so as to display the characters in English, the terminal apparatus 10b is set so as to display the characters in Japanese, and the terminal apparatus 10c is set so as to display the characters in Vietnamese. The terminal apparatus 10 is typically set so as to display the characters in a language commonly used by the user. Characters other than the characters in the language set by the user may also be displayed in the terminal apparatus 10, in addition to the characters in the language set by the user.

Each of the terminal apparatus 10 and the image forming apparatus 20 having the above configurations displays an operation screen that accepts an operation by the user to instruct the image forming apparatus 20 to execute the information processing.

FIG. 4 illustrates an operation screen R corresponding to the copy process, which is displayed in the image forming apparatus 20. As illustrated in FIG. 4, the operation screen R includes specification fields H1, H2, H3, and H4 that are arranged from left to right on the screen. Each of the specification fields H1 to H4 corresponds to one processing condition of the copy process. Each of the specification fields H1 to H4 includes options for processing parameters used in the copy process. The options are composed of radio buttons associated with the names of the processing parameters. Although the processing parameters are selected by the radio button method in the example in FIG. 4, the processing parameters may be selected by another method, such as a pull-down menu method. On the operation screen R, the processing parameter that is currently selected is indicated by “” and the processing parameters that are not currently selected are indicated by “◯.” The user touches the position of a radio button on the operation screen R with his/her finger to select (specify) the processing parameter.

The specification field H1 corresponds to “Color mode” as the processing condition. The “Color mode” is a condition of the kinds of toner used by the image forming unit 26 to form an image. The specification field H1 includes the options of three processing parameters: “Auto” in which the kinds of toner to be used are determined by the controller 21 depending on the colors used in the document, “Monochrome” in which only black toner is used, and “Full color” in which all the kinds of toner held in the image forming unit 26 are used. In the example illustrated n FIG. 4, the processing parameter of the “Color mode” is set to “Auto.”

The specification field H2 corresponds to “Paper selection” as the processing condition. The “Paper selection” is a condition of the size of sheets used by the image forming unit 26 to form an image. The specification field H2 includes the options of four processing parameters: “Auto” in which the size of sheets is determined by the controller 21 depending on the size of the document, “A4 vertical” in which A4-size sheets are vertically used, “A4 horizontal” in which the A4-size sheets are horizontally used, and “A3” in which A3-size sheets are vertically used. In the example illustrated in FIG. 4, the processing parameter of the “Paper selection” is set to “Auto.”

The specification field H3 corresponds to “Together in one” as the processing condition. The “Together in one” is a condition of the number of pages in image data with which one or more images are formed on one sheet. The specification field H3 includes the options of five processing parameters: “Not together” indicating that the images corresponding to multiple pages are not arranged on one sheet (that is, one sheet is used for the image data of one page), “Two pages” in which the images corresponding to two pages are arranged on one sheet, “Four pages” in which the images corresponding to four pages are arranged on one sheet, “Eight pages” in which the images corresponding to eight pages are arranged on one sheet, and “Sixteen pages” in which the images corresponding to sixteen pages are arranged on one sheet. In the example illustrated in FIG. 4, the processing parameter of the “Together in one” is set to “Not together.”

The specification field H4 corresponds to “Both sides/One side selection” as the processing condition. The “Both sides/One side selection” is a condition of a document face from which the image reading unit 25 reads out image data and a sheet face on which the image forming unit 26 forms an image. The specification field H4 includes the options of three processing parameters: “One side One side” in which image data is read out from one side of the document to form an image on one side of the sheet, “One side [symbol] Both sides” in which image data is read out from one side of the document to form images on both sides of the sheet, and “Both sides [symbol] Both sides” in which image data is read out from both side of the document to form images on both sides of the sheet. In the example illustrated in FIG. 4, the processing parameter of the “Both sides/One side selection” is set to “One side [symbol] One side.”

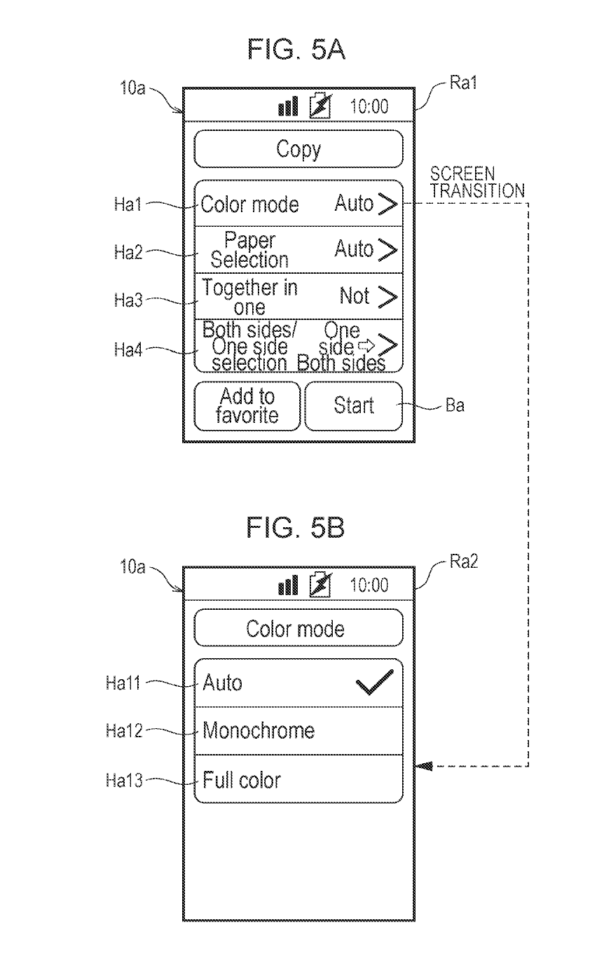

FIGS. 5A and 5B illustrate exemplary operation screens corresponding to the copy process, which are displayed in the terminal apparatus 10a.

FIG. 5A illustrates an operation screen Ra1 displayed in the terminal apparatus 10a. As illustrated in FIG. 5A, the operation screen Ra1 includes specification fields Ha1, Ha2, Ha3, and Ha4 that are arranged from the top to the bottom on the screen. In each of the specification fields Ha1 to Ha4 on the operation screen Ra1, the names of the processing conditions used in the copy process are associated with the names of the processing parameters that are currently selected. The specification field Ha1 corresponds to the “Color mode”, the specification field Ha2 corresponds to the “Paper selection”, the specification field Ha3 corresponds to the “Together in one”, and the specification field Ha4 corresponds to the “Both sides/One side selection.” In other words, the processing conditions the specification fields for which are displayed on the operation screen Ra1 coincide with the processing conditions the specifications fields for which are displayed on the operation screen R.

In the specification of a processing parameter, the user of the terminal apparatus 10a touches the position of the specification field corresponding to the processing parameter on the operation screen Ra1 with his/her finger. For example, when the user touches the specification field Ha1 with his/her finger, the terminal apparatus 10a makes the transition from the operation screen Ra1 illustrated in FIG. 5A to an operation screen Ra2 illustrated in FIG. 5B. The operation screen Ra2 is used to specify the processing parameter of the “Color mode” as the processing condition. As illustrated in FIG. 5B, the operation screen Ra2 includes specification fields Ha11, Ha12, and Ha13 that are arranged from the top to the bottom on the screen. Each of the specification fields Ha11 to Ha13 corresponds to the processing parameter option. Specifically, the specification field Ha11 corresponds to the “Auto” as the processing parameter, the specification field Ha12 corresponds to the “Monochrome” as the processing parameter, and the specification field Ha13 corresponds to the “Full color” as the processing parameter. In the example illustrated in FIG. 5B, a check mark indicating that the processing parameter is set to “Auto” is added to the specification field Ha11. In order to change the processing parameter, the user touches the specification field corresponding to the desired processing parameter, among the specification fields Ha11 to Ha13, with his/her finger.

Also in the specification of the processing parameter of the processing condition other than the “Color mode”, upon selection of a specification field on the operation screen Rat by the user, the terminal apparatus 10a makes the transition to the screen including the options of the processing parameters corresponding to the selected specification field to accept the operation to specify the processing parameter. Since the operation screen corresponding to each processing condition, the operation to be performed by the user, and so on are apparent from the description of the “Color mode”, a description of the processing conditions other than the “Color mode” is omitted herein.

Upon completion of the setting of the processing conditions, the user of the terminal apparatus 10a touches a “Start” soft button Ba on the operation screen Ra1 with his/her finger. In response to the operation of the soft button Ba by the user, the terminal apparatus 10a instructs the image forming apparatus 20 via the communication line 100 to execute the copy process under the processing conditions that are set.

As described above, the terminal apparatus 10a displays the operation screens in English to accept the operation to instruct the image forming apparatus 20 to execute the information processing by using English.

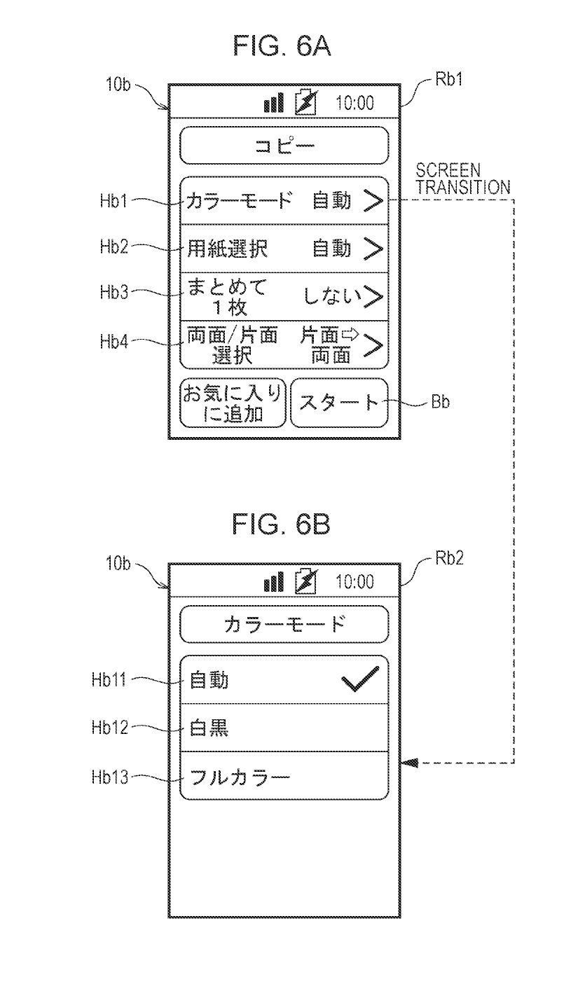

FIGS. 6A and 6B illustrate exemplary operation screens corresponding to the copy process, which are displayed in the terminal apparatus 10b.

FIG. 6A illustrates an operation screen Rb1 displayed in the terminal apparatus 10b. As illustrated in FIG. 6A, the operation screen Rb1 is substantially equal to the screen resulting from translation of the English characters included in the operation screen Ra1 into Japanese. The screen Rb1 includes specification fields Hb1, Hb2, Hb3, and Hb4 that are arranged from the top to the bottom on the screen. The specification field Hb1 corresponds to the “Color mode” as the processing condition, the specification field Hb2 corresponds to the “Paper selection” as the processing condition, the specification field Hb3 corresponds to the “Together in one” as the processing condition, and the specification field Hb4 corresponds to the “Both sides/One side selection” as the processing condition.

In the specification of a processing parameter, the user of the terminal apparatus 10b touches the position of the specification field corresponding to the processing parameter on the operation screen Rb1 with his/her finger while the operation screen Rb1 is being displayed. For example, when the user touches the specification field Hb1 with his/her finger, the terminal apparatus 10b makes the transition from the operation screen Rb1 illustrated in FIG. 6A to an operation screen Rb2 illustrated in FIG. 6B. The operation screen Rb2 is used to specify the processing parameter of the “Color mode” as the processing condition. As illustrated in FIG. 6B, the operation screen Rb2 is substantially equal to the screen resulting from translation of the English characters included in the operation screen Ra2 into Japanese. The operation screen Rb2 includes specification fields Hb11, Hb12, and Hb13 that are arranged from the top to the bottom on the screen. Specifically, the specification field Hb11 corresponds to the “Auto” as the processing parameter, the specification field Hb12 corresponds to the “Monochrome” as the processing parameter, and the specification field Hb13 corresponds to the “Full color” as the processing parameter.

The user of the terminal apparatus 10b touches the specification field corresponding to the desired processing parameter with his/her finger to specify the processing parameter.

Upon completion of the setting of the processing conditions, the user of the terminal apparatus 10b touches a soft button Bb on the operation screen Rb1 with his/her finger. In response to the operation of the soft button Bb by the user, the terminal apparatus 10b instructs the image forming apparatus 20 via the communication line 100 to execute the copy process under the processing conditions that are set.

As described above, the terminal apparatus 10b displays the operation screens in Japanese to accept the operation to instruct the image forming apparatus 20 to execute the information processing by using Japanese.

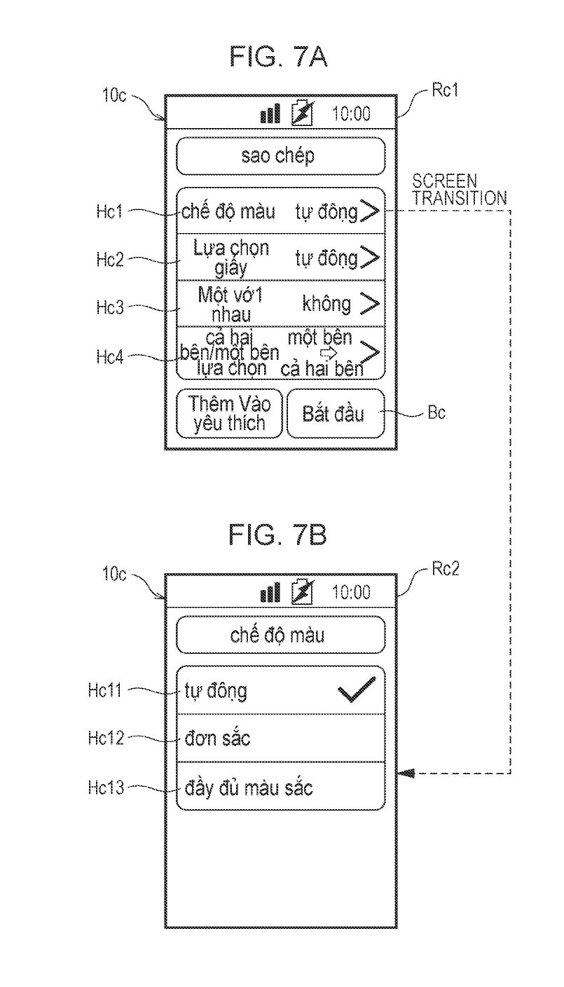

FIGS. 7A and 7B illustrate exemplary operation screens corresponding to the copy process, which are displayed in the terminal apparatus 10c.

FIG. 7A illustrates an operation screen Rc1 displayed in the terminal apparatus 10c. As illustrated in FIG. 7A, the operation screen Rc1 is substantially equal to the screen resulting from translation of the English characters included in the operation screen Rat into Vietnamese. The screen Rc1 includes specification fields Hc1, Hc2, Hc3, and Hc4 that are arranged from the top to the bottom on the screen. The specification field Hc1 corresponds to the “Color mode” as the processing condition, the specification field Hc2 corresponds to the “Paper selection” as the processing condition, the specification field Hc3 corresponds to the “Together in one” as the processing condition, and the specification field Hc4 corresponds to the “Both sides/One side selection” as the processing condition.

In the specification of a processing parameter, the user of the terminal apparatus 10c touches the position of the specification field corresponding to the processing parameter on the operation screen Rc1 with his/her finger while the operation screen Rc1 is being displayed. For example, when the user touches the specification field Hc1 with his/her finger, the terminal apparatus 10c makes the transition from the operation screen Rc1 illustrated in FIG. 7A to an operation screen Rc2 illustrated in FIG. 7B. The operation screen Rc2 is used to specify the processing parameter of the “Color mode” as the processing condition. As illustrated in FIG. 7B, the operation screen Rc2 is substantially equal to the screen resulting from translation of the English characters included in the operation screen Ra2 into Vietnamese. The operation screen Rc2 includes specification fields Hc11, Hc12, and Hc13 that are arranged from the top to the bottom on the screen. Specifically, the specification field Hc11 corresponds to the “Auto” as the processing parameter, the specification field Hc12 corresponds to the “Monochrome” as the processing parameter, and the specification field Hc13 corresponds to the “Full color” as the processing parameter.

The user of the terminal apparatus 10c touches the specification field corresponding to the desired processing parameter with his/her finger to specify the processing parameter.

Upon completion of the setting of the processing conditions, the user of the terminal apparatus 10c touches a soft button Bc on the operation screen Rc1 with his/her finger. In response to the operation of the soft button Bc by the user, the terminal apparatus 10c instructs the image forming apparatus 20 via the communication line 100 to execute the copy process under the processing conditions that are set.

As described above, the terminal apparatus 10c displays the operation screens in Vietnamese to accept the operation to instruct the image forming apparatus 20 to execute the information processing by using Vietnamese.

As described above, the terminal apparatus 10 displays the operation screens in the language set by the user, among the languages indicated by the used language information 152, to accept the operation to specify the processing parameter. The terminal apparatus 10 also displays the operation screens for the scanning process and the facsimile transmission process as the information processing other than the copy process in the language set by the user.

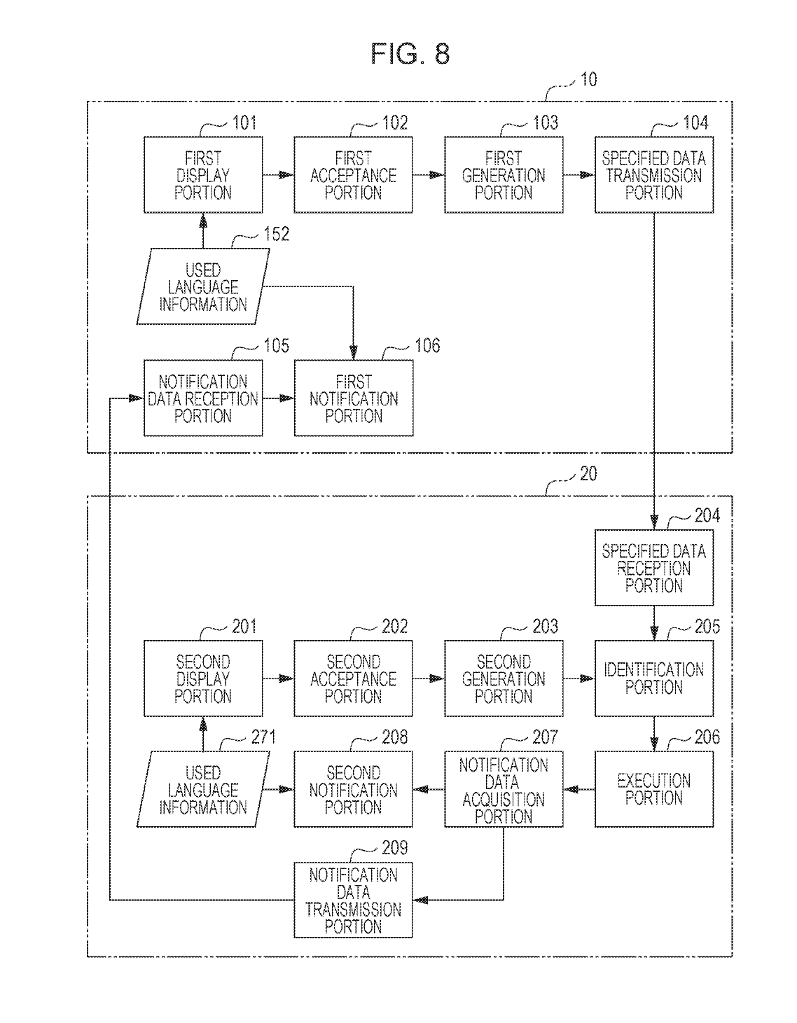

FIG. 8 is a block diagram illustrating an exemplary functional configuration of the terminal apparatus 10 and the image forming apparatus 20. As illustrated in FIG. 8, the terminal apparatus 10 executes the operation application 151 to realize functions corresponding to a first display portion 101, a first acceptance portion 102, a first generation portion 103, a specified data transmission portion 104, a notification data reception portion 105, and a first notification portion 106. The image forming apparatus 20 executes the control program to realize functions corresponding to a second display portion 201, a second acceptance portion 202, a second generation portion 203, a specified data reception portion 204, an identification portion 205, an execution portion 206, a notification data acquisition portion 207, a second notification portion 208, and a notification data transmission portion 209.

The first display portion 101 in the terminal apparatus 10 displays the operation screens including the processing parameter options in a first language on the basis of the used language information 152 (an example of first language information). In the present exemplary embodiment, the first display portion 101 displays the operation screens by using English.

The first acceptance portion 102 accepts a first instruction instructing the image forming apparatus 20 to execute the information processing from the user in the first language (English here) used by the first display portion 101. More specifically, the first acceptance portion 102 accepts the first instruction with the operation to select the option while displaying the processing parameter options in the first language with the first display portion 101 (for example, any of the operation screens in FIGS. 5A and 5B to FIGS. 7A and 7B).

The first generation portion 103 generates first instruction data representing the instruction accepted by the first acceptance portion 102. The first instruction data is used to identify the information processing indicated by the user. The first instruction data is described in, for example, an intermediate language and does not depend on the language used by the first display portion 101 to display the operation screens. The first instruction data includes, for example, the communication address of the terminal apparatus 10, which is a transmission source, the kind of the information processing, and the processing parameters.

The specified data transmission portion 104 transmits the first instruction data generated by the first generation portion 103 to the image forming apparatus 20.

The second display portion 201 in the image forming apparatus 20 displays the operation screen including the processing parameter options in a second language on the basis of the used language information 271 (an example of second language information). The second display portion 201 may display the operation screen in a language other than English.

The second acceptance portion 202 accepts a second instruction instructing the image forming apparatus 20 to execute the information processing from the user in the second language used by the second display portion 201. More specifically, the second acceptance portion 202 accepts the second instruction with the operation to select the option while displaying the processing parameter options in the second language with the second display portion 201 (for example, the operation screen R in FIG. 4).

The second generation portion 203 generates second instruction data representing the instruction accepted by the second acceptance portion 202. The second instruction data is used to identify the information processing indicated by the user. The second instruction data is described in, for example, an intermediate language and does not depend on the language used by the second display portion 201 to display the operation screen. The second instruction data includes, for example, the kind of the information processing and the processing parameters.

The specified data reception portion 204 receives the first instruction data transmitted from the specified data transmission portion 104.

The identification portion 205 identifies the information processing the execution of which is indicated on the basis of the first instruction data received by the specified data reception portion 204 or the second instruction data generated by the second generation portion 203. The identification portion 205 interrupts any instruction data that is supplied from either of the specified data reception portion 204 and the second generation portion 203 to identify, for example, the processing condition including the kind of the information processing the execution of which is indicated and the processing parameters.

The execution portion 206 executes the information processing identified by the identification portion 205. The execution portion 206 executes the information processing of the kind identified by the identification portion 205 by using the processing parameters identified by the identification portion 205.

The functional configuration in which the image forming apparatus 20 executes the information processing in response to the operation by the user to instruct the execution of the information processing is described above. The terminal apparatus 10 and the image forming apparatus 20 also realize a function to notify the user of a matter to be notified about the image forming apparatus 20.

The notification data acquisition portion 207 acquires notification data representing the matter to be notified about the image forming apparatus 20. The notification data acquisition portion 207 acquires the notification data about, for example, an error that has occurred when the execution portion 206 has executed the information processing.

The second notification portion 208 notifies the user of the matter to be notified about the image forming apparatus 20 in the same second language as that in the second display portion 201 on the basis of the notification data acquired by the notification data acquisition portion 207. The second notification portion 208 may refer to the used language information 271 to determine the language used in the notification. For example, the second notification portion 208 notifies the user of the error that has occurred.

The notification data transmission portion 209 transmits the notification data acquired by the notification data acquisition portion 207 to the terminal apparatus 10.

The notification data reception portion 105 in the terminal apparatus 10 receives the notification data transmitted from the notification data transmission portion 209.

The first notification portion 106 notifies the user of the matter to be notified about the image forming apparatus 20 in the same first language as that in the first display portion 101 on the basis of the notification data received by the notification data reception portion 105. The first notification portion 106 may refer to the used language information 152 to determine the language used in the notification. For example, the first notification portion 106 notifies the user of the error that has occurred.

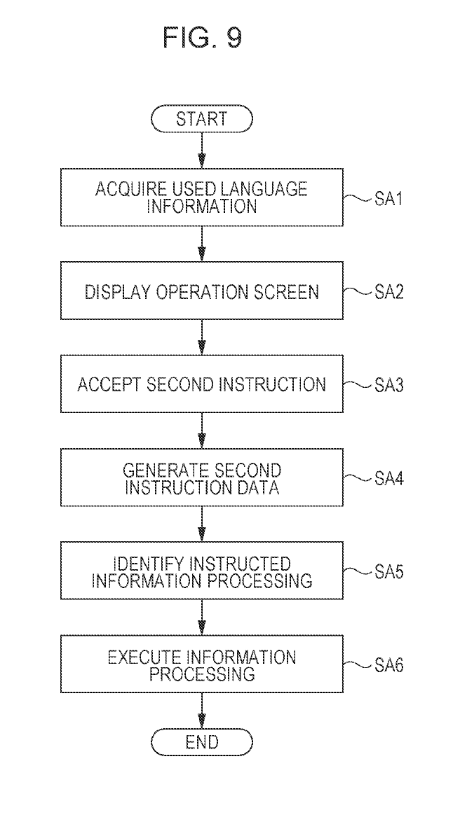

FIG. 9 is a flowchart illustrating an exemplary process in the image forming apparatus 20 when the execution of the copy process is indicated by a direct operation to the image forming apparatus 20.

Referring to FIG. 9, in Step SA1, the controller 21 in the image forming apparatus 20 reads out the used language information 271 stored in the memory 27 to acquire the used language information 271. In Step SA2, the controller 21 displays the operation screen in the display 24 in the language used in the image forming apparatus 20 on the basis of the acquired used language information 271. Here, the controller 21 displays the operation screen by using English regardless of the user.

In Step SA3, the controller 21 accepts the second instruction to instruct the execution of the copy process with the operation by the user with the operation unit 22 while displaying the operation screen displayed in Step SA2. Here, the controller 21 displays the operation screen R illustrated in FIG. 4 in the display 24 to accept the operation by the user.

In Step SA4, the controller 21 generates the second instruction data representing the second instruction from the user upon acceptance of an operation to indicate start of the copy process. For example, the controller 21 converts information acquired in response to the second instruction into the second instruction data described in an intermediate language or the like, which does not depend on the used language.

In Step SA5, the controller 21 identifies the information processing the execution of which is indicated on the basis of the generated second instruction data. When the execution of the copy process is indicated on the operation screen R illustrated in FIG. 4, the controller 21 identifies the execution of the information processing in which the Color mode is set to “Auto”, the Paper selection is set to “Auto”, the Together in one is set to “Not together”, and the Both sides/One side selection is set to One side [symbol] One side.

In Step SA6, the controller 21 controls each component in the image forming apparatus 20 so as to execute the identified information processing. Here, the controller 21 causes the image reading unit 25 to read an image of a document to cause the image forming unit 26 to form an image corresponding to image data generated by the image reading unit 25 on a sheet.

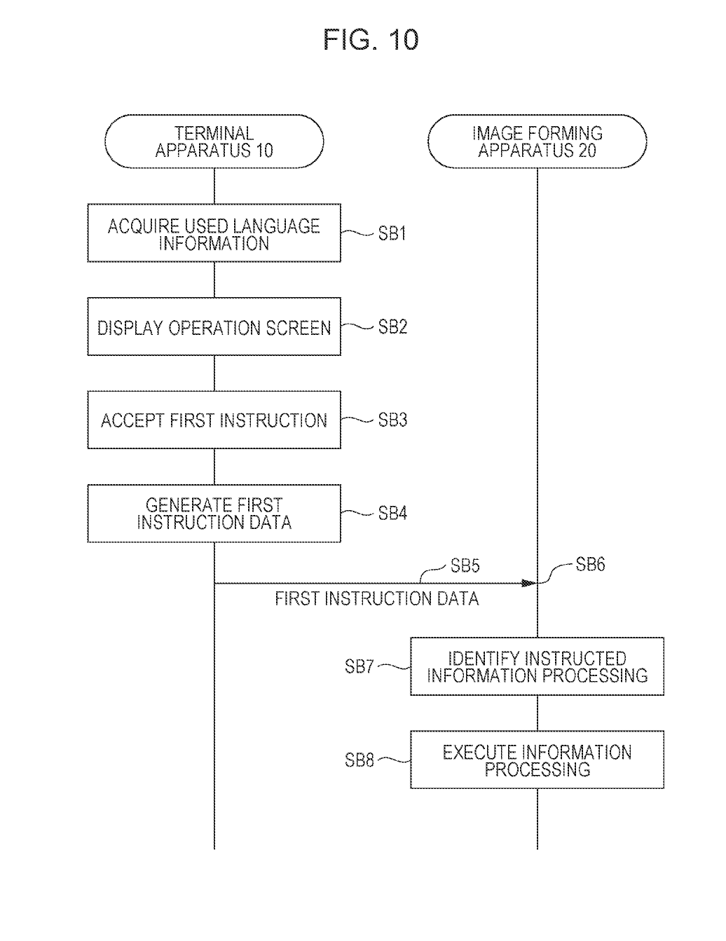

FIG. 10 is a sequence chart illustrating an exemplary process in the information processing system 1 when the terminal apparatus 10 instructs the image forming apparatus 20 to execute the copy process.

Referring to FIG. 10, in Step SB1, the controller 11 in the terminal apparatus 10 reads out the used language information 152 stored in the memory 15 to acquire the used language information 152. In Step SB2, the controller 11 displays the operation screen in the display 14 in the language used in the terminal apparatus 10 on the basis of the acquired used language information 152. Here, the terminal apparatus 10a for which “English”, among the used languages, is set displays, for example, the operation screen Ra1 and Ra2 illustrated in FIGS. 5A and 5B, respectively. The terminal apparatus 10b for which “Japanese”, among the used languages, is set displays, for example, the operation screens Rb1 and Rb2 illustrated in FIGS. 6A and 6B, respectively. The terminal apparatus 10c for which “Vietnamese”, among the used languages, is set displays, for example, the operation screens Rc1 and Rc2 illustrated in FIGS. 7A and 7B, respectively. These languages are commonly used by the users of the respective terminal apparatuses 10. The languages used on the operation screens of the terminal apparatus 10b and the terminal apparatus 10c are different from the language used on the operation screen of the image forming apparatus 20.

In Step SB3, the controller 11 in the terminal apparatus 10 accepts the first instruction to instruct the image forming apparatus 20 to execute the copy process with the operation by the user with the operation unit 12 while displaying the operation screen displayed in Step SB2. The controller 11 accepts the operation by the user by using the operation screen (for example, any of the operation screens illustrated in FIGS. 5A and 5B to FIGS. 7A and 7B) displayed in the display 14.

In Step SB4, the controller 11 generates the first instruction data representing the first instruction from the user upon acceptance of an operation to indicate start of the copy process from the user. For example, the controller 11 converts information acquired in response to the first instruction into the first instruction data described in an intermediate language or the like, which does not depend on the used language. Accordingly, the pieces of first instruction data indicating the execution of the same information processing has the same structure regardless of the language used in the display of the operation screens. In addition, the first instruction data and the second instruction data indicating the execution of the same information processing has, for example, the same structure.

Upon completion of the operation to specify the processing condition and selection of the button corresponding to the Start button (the soft button Ba illustrated in FIG. 5A, the soft button Bb illustrated in FIG. 6A, or the soft button Bc illustrated in FIG. 7A) by the user, in Step SB5, the controller 11 transmits the generated first instruction data to the image forming apparatus 20 with the communication unit 13.

In Step SB6, the controller 21 in the image forming apparatus 20 receives the first instruction data transmitted from the terminal apparatus 10 with the communication unit 23. In Step SB7, the controller 21 identifies the information processing the execution of which is indicated on the basis of the received first instruction data. When the execution of the copy process is indicated on any of the operation screens illustrated in FIGS. 5A and 5b FIGS. 7A and 7B, the controller 21 identifies the execution of the information processing in which the Color mode is set to “Auto”, the Paper selection is set to “Auto”, the Together in one is set to “Not together”, and the Both sides/One side selection is set to One side [symbol] One side.

In Step SB8, the controller 21 controls each component in the image forming apparatus 20 so as to execute the identified information processing. Here, the controller 21 causes the image reading unit 25 to read an image of a document to cause the image forming unit 26 to form an image corresponding to image data generated by the image reading unit 25 on a sheet.

With the above process, the image forming apparatus 20 executes the information processing indicated in the language used in the terminal apparatus 10 that is operated by the user regardless of the language used in the image forming apparatus 20.

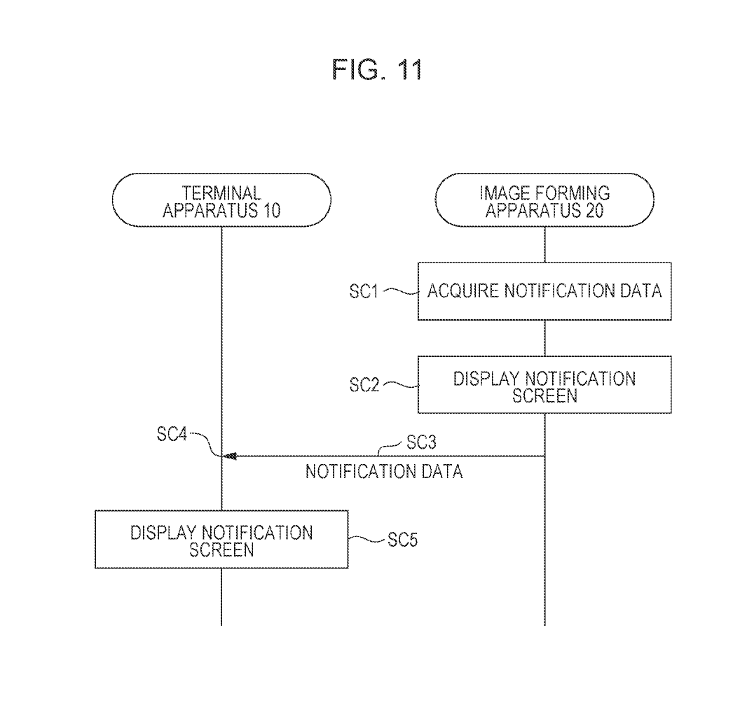

FIG. 11 is a sequence chart illustrating an exemplary process in the information processing system 1 when a notification of an error that has occurred in the image forming apparatus 20 is to be made.

Referring to FIG. 11, in Step SC1, the controller 21 in the image forming apparatus 20 acquires the notification data. When any error has occurred during the execution of the information processing, the controller 21 acquires an error code identifying the error as the notification data.

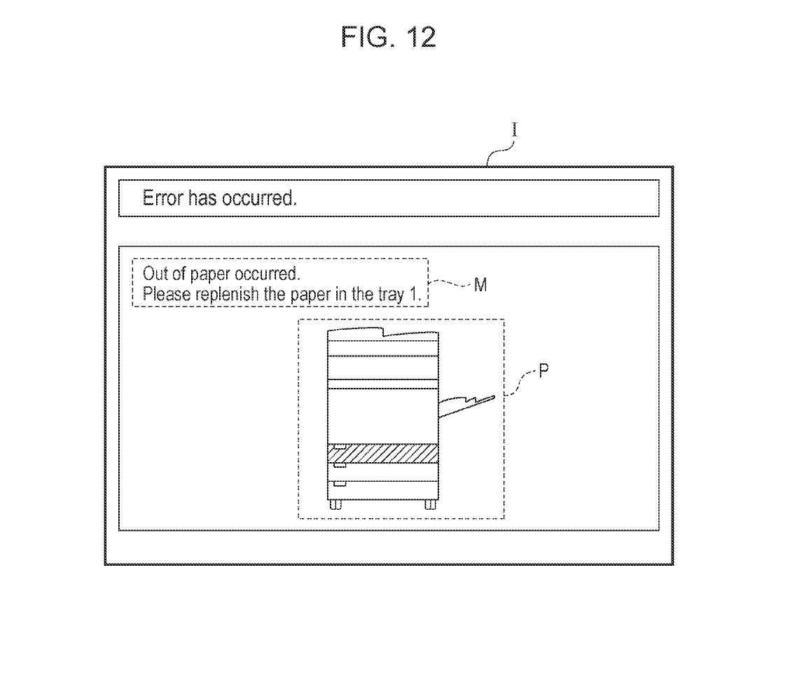

In Step SC2, the controller 21 displays a notification screen indicating that the error has occurred in the display 24 on the basis of the acquired notification data. Here, the controller 21 refers to a table (not illustrated) in which the error codes stored in the memory 27 are associated with the matters to be indicated to display the notification screen corresponding to the error code in the display 24. The image forming apparatus 20 displays an error notification screen I illustrated in FIG. 12. As illustrated in FIG. 12, on the error notification screen I, the content of the error that has occurred and an action to be taken by the user are displayed, along with a message “Error has occurred.” The notification screen when out-of-paper occurred is illustrated in FIG. 12. A message M “Out of paper occurred. Please replenish the paper in the tray 1.” and an image P indicating the position of the tray 1 in a schematic external view of the image forming apparatus 20 are displayed on the error notification screen I in FIG. 12. The controller 21 in the image forming apparatus 20 determines the language used in the display of the message M on the basis of the used language information 271. The controller 21 displays the message M in English on the error notification screen I in FIG. 12.

Referring back to FIG. 11, in Step SC3, the controller 21 transmits the notification data acquired in Step SC1 to the terminal apparatus 10 with the communication unit 23, in parallel with Step SC2. For example, the controller 21 uses the communication address of the terminal apparatus 10, which is the transmission source, included in the instruction data to transmit the notification data. In Step SC4, the controller 11 in the terminal apparatus 10 receives the notification data transmitted from the image forming apparatus 20 with the communication unit 13. In Step SC5, the controller 11 displays the error notification screen indicating that an error has occurred in the display 14 on the basis of the received notification data.

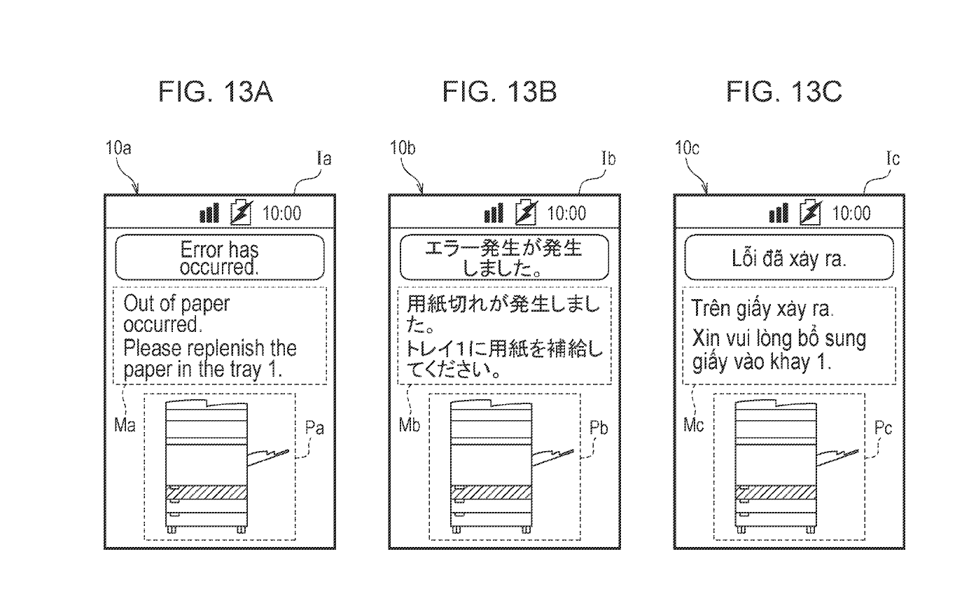

The terminal apparatus 10 displays an error notification screen illustrated in FIG. 13A, FIG. 13B, or FIG. 13C. FIG. 13A illustrates an error notification screen Ia displayed in the terminal apparatus 10a. FIG. 13B illustrates an error notification screen Ib displayed in the terminal apparatus 10b. FIG. 13C illustrates an error notification screen Ic displayed in the terminal apparatus 10c. As illustrated in FIGS. 13A to 13C, the language set by the user, among the used languages represented by the used language information 152, is used in the characters on the error notification screen in the terminal apparatus 10. Accordingly, the terminal apparatus 10a displaying the characters in English displays a message Ma composed of the same characters as those of the message M and an image Pa that is equal to the image P, as illustrated in FIG. 13A. The terminal apparatus 10b displaying the characters in Japanese displays a message Mb resulting from translation of the message M into Japanese and an image Pb that is equal to the image P, as illustrated in FIG. 13B. The terminal apparatus 10c displaying the characters in Vietnamese displays a message Mc resulting from translation of the message M into Vietnamese and an image Pc that is equal to the image P, as illustrated in FIG. 13C. In other words, the characters included in each notification screen are displayed in the language conforming to the setting in the corresponding terminal apparatus 10. In contrast, the same image is included in the notification screens regardless of the used languages.

Although the error indicated on the error notification screen is out of paper in the above examples, another error, such as out of toner or paper jam, may be indicated on the error notification screen.

Although the operation of the information processing system 1 is described above, taking the copy process as an example, the information processing system 1 operates in the above manner even in the scanning process and the facsimile transmission process.

The controller 21 transmits the notification data, which is information about an error that has occurred in the image forming apparatus 20, to the terminal apparatus 10. The notification data includes at least one of an error code and information indicating a matter to be indicated. For example, when the terminal apparatus 10 receives the notification data that does not include the information indicating a matter to be indicated but includes an error code, the terminal apparatus 10 may use the error code included in the received notification data to identify the matter to be indicated by referring to a table in which the error codes stored in the terminal apparatus 10 are associated with the matters to be indicated. The terminal apparatus 10 may identify the matter to be indicated (action) in the above manner to generate the action to be displayed in the error notification screen. For example, when the terminal apparatus 10 receives the error code including the information to be indicated, the terminal apparatus 10 generates the content to be displayed on the error notification screen from the received information indicating the matter to be indicated. Specifically, when the information indicating the matter to be indicated represents the content of the error and the action to be taken by the user and the information is compressed text data or image data, the terminal apparatus 10 decompresses the received information indicating the matter to be indicated to display the decompressed text data or image data on the error notification screen of the terminal apparatus 10. The content of the error in the image forming apparatus 20 and the action to be taken by the user are displayed in the terminal apparatus 10. In this case, the language in which the content of the error and the action to be taken by the user are displayed in the image forming apparatus 20 may be different from the language in which the content of the error and the action to be taken by the user are displayed in the terminal apparatus 10, as in the above exemplary embodiments.

In the information processing system 1 described in the above exemplary embodiments, the image forming apparatus 20 executes the information processing indicated by the user by using the terminal apparatus 10 even if the language used in the image forming apparatus 20 is different from the language used in the terminal apparatus 10. In the notification of an occurrence of an error by the image forming apparatus 20, the image forming apparatus 20 notifies the error in the language used in the image forming apparatus 20. In contrast, the terminal apparatus 10 notifies the occurrence of the error in the language used in the terminal apparatus 10, for example, the language commonly used by the user of the terminal apparatus 10. The image forming apparatus 20 may not store information about the language used in the terminal apparatus 10 or the language commonly used by the user of the terminal apparatus 10 and may not execute the processing using the information.

The present invention may be embodied in exemplary embodiments different from the above exemplary embodiments. Modifications described below may be appropriately combined.

The languages used in the terminal apparatus 10 and the image forming apparatus 20 in the above exemplary embodiments are only examples and, for example, another language (natural language), such as Chinese or Portuguese, may be used.

Although the language used in the image forming apparatus 20, represented by the used language information 271, is common to the language (English) which is part of the languages used in the terminal apparatus 10, represented by the used language information 152, and the remaining languages (for example, Japanese and Vietnamese) among the languages used in the terminal apparatus 10 are not common to the language used in the image forming apparatus 20 in the above exemplary embodiments, the language used in the image forming apparatus 20 may not be common to all the languages used in the terminal apparatus 10. Specifically, the image forming apparatus 20 may not store the language information indicating the languages used in the terminal apparatus 10. In other words, the terminal apparatus 10 may not store the language information indicating the language used in the image forming apparatus 20. Accordingly, the language used in the display of the operation screen in the terminal apparatus 10 when the terminal apparatus 10 accepts the instruction to execute the information processing may be different from the language used in the display of the operation screen in the image forming apparatus 20 when the image forming apparatus 20 receives the instruction data representing the instruction.

Each of the terminal apparatus 10 and the image forming apparatus 20 stores the used language information in the above exemplary embodiments. However, instead of the storage of the used language information, each of the terminal apparatus 10 and the image forming apparatus 20 may acquire the used language information from an apparatus on a network, such as a server apparatus, by communication.

The processing parameters described in the above exemplary embodiments are only examples. For example, the processing parameters concerning the resolution in reading of an image in the image reading unit 25, the file format of image data that is generated, and the image quality, such as the density, of an image formed by the image forming unit 26 may be included and the processing parameters concerning postprocessing, such as a stapling process, in the image forming apparatus 20 may be included.

Although each of the image forming apparatus 20 and the terminal apparatus 10 indicates the error that has occurred in the execution of the information processing in the information processing system 1 in the above exemplary embodiments, a matter other than the occurrence of the error may be indicated. In the information processing system 1, for example, the state of the image forming apparatus 20, such as the remaining amount of sheets of paper in each tray and the remaining amount of toner, may be indicated. In addition, in the information processing system 1, a history of the information processing that has been executed by the image forming apparatus 20 may be indicated. For example, the history of the communication with the communication unit 13 and/or the history of the image forming processes that have been executed with the image forming unit 26 may be indicated. Each of the image forming apparatus 20 and the terminal apparatus 10 indicates the information in the language set by the user, among the used languages, by the process described above with reference to FIG. 11 regardless of the matter to be indicated.

Although the information processing apparatus according to an exemplary embodiment of the present invention is applied to the image forming apparatus 20 in the above exemplary embodiments, the information processing apparatus according to the exemplary embodiment of the present invention may not have the image formation function. It is sufficient for the information processing apparatus according to the exemplary embodiment of the present invention to execute the information processing indicated with a direct operation of the information processing apparatus and to execute the information processing indicated with an operation of the terminal apparatus and the content of the information processing is not particularly specified. Accordingly, the information processing apparatus according to the exemplary embodiment of the present invention may be, for example, a personal computer.

Part of the configuration and the operation of the information processing system 1 described in the above exemplary embodiments may be omitted. For example, the information processing system 1 may not have the configuration to indicate the information on the basis of the notification data. The identification portion 205 realized in the image forming apparatus 20 may be modified so as to realize only the function to identify the information processing on the basis of the instruction data received from the terminal apparatus 10 and the function corresponding to the second acceptance portion 202 in the image forming apparatus 20 may be omitted. Even when such modifications are made, the image forming apparatus 20 has the function to execute the information processing indicated by using the terminal apparatus 10 in a configuration in which the language used in the image forming apparatus 20 is different from the language used in the terminal apparatus 10.

The various screens displayed in the terminal apparatus 10 and the image forming apparatus 20 described in the above exemplary embodiments are only examples, and the operation methods to be performed by the users by using the designs of the screens and the screens are not limited to the ones described in the above exemplary embodiments.

Each function realized by the terminal apparatus 10 and the image forming apparatus 20 in the above exemplary embodiments may be realized by one or more hardware circuits, an arithmetic apparatus may execute one or more programs to realize each function, or each function may be realized by a combination of the above methods.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a terminal apparatus; and
an information processing apparatus,
wherein the terminal apparatus includes
a first language information memory that stores first language information representing a first language as language information indicating a display mode of a language in the terminal apparatus;
a first display that displays a processing parameter option used in information processing in the first language based on the first language information;
a first acceptance unit that accepts a first instruction instructing the information processing apparatus to execute the information processing with an operation to select the option while displaying the option in the first language with the first display;
a first generation unit that generates first instruction data representing the first instruction;
an instruction data transmission unit that transmits the first instruction data to the information processing apparatus;
a notification data reception unit that receives notification data indicating the content of an error that has occurred in the information processing apparatus and an action to resolve the error from the information processing apparatus; and
a first notification unit that notifies a user of the content of the error and the action in the first language based on the notification data received by the notification data reception unit, and
wherein the information processing apparatus includes
a second language information memory that stores second language information representing a second language different from the first language as language information indicating a display mode of a language in the information processing apparatus;
a second display that displays the processing parameter option in the second language based on the second language information;
a second acceptance unit that accepts a second instruction indicating the execution of the information processing with an operation to select the option while displaying the option in the second language with the second display;
a second generation unit that generates second instruction data representing the second instruction;
an instruction data reception unit that receives the first instruction data transmitted from the instruction data transmission unit;
an identification unit that identifies the information processing the execution of which is indicated based on the first instruction data received by the instruction data reception unit or the second instruction data generated by the second generation unit;
an execution unit that executes the information processing identified by the identification unit;
a notification data acquisition unit that acquires the notification data indicating the content of the error and the action;
a notification data transmission unit that transmits the notification data acquired by the notification data acquisition unit to the terminal apparatus identified by information indicating a transmission source included in the first instruction data; and
a second notification unit that notifies a user of the content of the error and the action in the second language based on the acquired notification data.

2. An information processing system comprising:
a terminal apparatus; and
an information processing apparatus,
wherein the terminal apparatus includes
a first language information memory that stores first language information representing a first language as language information indicating a display mode of a language in the terminal apparatus;
a first display that displays a processing parameter option used in information processing in the first language based on the first language information;
a first acceptance unit that accepts a first instruction instructing the information processing apparatus to execute the information processing with an operation to select the option while displaying the option in the first language with the first display;
a first generation unit that generates first instruction data representing the first instruction;
an instruction data transmission unit that transmits the first instruction data to the information processing apparatus;
a notification data reception unit that receives notification data about an error that has occurred in the information processing apparatus from the information processing apparatus; and
a first notification unit that notifies a user of a matter to be indicated in the first language based on the notification data received by the notification data reception unit, and
wherein the information processing apparatus includes
a second language information memory that stores second language information representing a second language different from the first language as language information indicating a display mode of a language in the information processing apparatus;
a second display that displays the processing parameter option in the second language based on the second language information;
a second acceptance unit that accepts a second instruction indicating the execution of the information processing with an operation to select the option while displaying the option in the second language with the second display;
a second generation unit that generates second instruction data representing the second instruction;
an instruction data reception unit that receives the first instruction data transmitted from the instruction data transmission unit;
an identification unit that identifies the information processing the execution of which is indicated based on the first instruction data received by the instruction data reception unit or the second instruction data generated by the second generation unit;
an execution unit that executes the information processing identified by the identification unit;
a notification data acquisition unit that acquires the notification data about the error that has occurred in the information processing apparatus;
a notification data transmission unit that transmits the notification data acquired by the notification data acquisition unit to the terminal apparatus identified by information indicating a transmission source included in the first instruction data; and
a second notification unit that notifies a user of the matter to be indicated in the second language based on the acquired notification data.

3. The information processing system according to claim 2,
wherein the second notification unit identifies the matter to be indicated with the notification data by referring to a table in which the notification data stored in the terminal apparatus is associated with the matter to be indicated.

4. An information process method comprising:
storing first language information representing a first language as language information indicating a display mode of a language in a terminal apparatus by the terminal apparatus;
displaying a processing parameter option used in information processing in the first language based on the first language information by the terminal apparatus;
accepting a first instruction instructing an information processing apparatus to execute the information processing with an operation to select the option while displaying the option in the first language by the terminal apparatus;
generating first instruction data representing the first instruction by the terminal apparatus;
transmitting the first instruction data to the information processing apparatus by the terminal apparatus;
receiving notification data about an error that has occurred in the information processing apparatus from the information processing apparatus by the terminal apparatus;
notifying a user of a matter to be indicated in the first language based on the received notification data by the terminal apparatus;
storing second language information representing a second language different from the first language as language information indicating a display mode of a language in the information processing apparatus by the information processing apparatus;
displaying the processing parameter option in the second language based on the second language information by the information processing apparatus;
accepting a second instruction indicating the execution of the information processing with an operation to select the option while displaying the option in the second language by the information processing apparatus;
generating second instruction data representing the second instruction by the information processing apparatus;
receiving the transmitted first instruction data by the information processing apparatus;
identifying the information processing the execution of which is indicated based on the received first instruction data or the generated second instruction data by the information processing apparatus;
executing the identified information processing by the information processing apparatus;
acquiring the notification data about the error that has occurred in the information processing apparatus by the information processing apparatus;
transmitting the acquired notification data to the terminal apparatus identified by information indicating a transmission source included in the first instruction data by the information processing apparatus; and
notifying a user of the matter to be indicated in the second language based on the acquired notification data by the information processing apparatus.
